(19) United States
(12) Patent Application Publication
(10) Pub. No.: US 2021/0329031 A1
(43) Pub. Date: Oct. 21, 2021

(54) HONEYPOT HOST

(71) Applicants: Zanoramy Ansiry Zakaria WIRA, Kuala Lumpur (MY); Rohaidah Ahmad SITI, Kuala Lumpur (MY); Ahmad ARNIYATI, Kuala Lumpur (MY); Abdul Mutalib ABDUL MUZAIRE, Kuala Lumpur (MY); Abdul Aziz NORAZAH, Kuala Lumpur (MY)

(72) Inventors: Zanoramy Ansiry Zakaria WIRA, Kuala Lumpur (MY); Rohaidah Ahmad SITI, Kuala Lumpur (MY); Ahmad ARNIYATI, Kuala Lumpur (MY); Abdul Mutalib ABDUL MUZAIRE, Kuala Lumpur (MY); Abdul Aziz NORAZAH, Kuala Lumpur (MY)

(73) Assignee: MIMOS BHD., Kuala Lumpur (MY)

(21) Appl. No.: 13/063,612

(22) PCT Filed: Sep. 11, 2009
(86) PCT No.: PCT/MY2009/000145

§ 371 Date: Aug. 14, 2012

(30) Foreign Application Priority Data
Sep. 12, 2008 (MY) PI20083551

(51) Int. Cl. H04L 29/06; G06F 9/455

(52) U.S. Cl. CPC H04L 63/1491; G06F 2009/45562; G06F 9/45558; G06F 9/45545

(57) ABSTRACT

The present invention relates to a honeypot host (500) adapted in a network (90). The honeypot host (500) of the present invention is generally comprised of a computer system (10) and a honeypot system (300) incorporated in the computer system (10). The honeypot system (300) generally deploys at least one decoy host 80 to at least one unused Internet Protocol (IP) address (160) around the network (90). The honeypot system (300) is further adapted to be self-replicable. In the event that a honeypot system (300) in the network (90) is compromised, the honeypot system (300) is capable of self-terminating at least a portion of the compromised honeypot system (300) and self-replicating a new honeypot system (300). The honeypot system (300) is also further adapted to detect whether the current honeypot system (300) has been compromised. The present invention is also related in another aspect to a method for replicating a honeypot system (300) to replace a compromised honeypot system (300).

### FIELD OF THE INVENTION

The present invention relates to a honeypot host adapted to a network.

### BACKGROUND ART

It has been quite common in computer technology that the honeypot systems are developed for network security. A honeypot system is generally the most secure defense mechanism in a network to detect and prevent attacks on the network.

There are also some honeypot systems that are facilitated to generate decoy hosts around the unused Internet Protocol (IP) addresses. The decoy hosts are camouflaged like real computers in the network but in the actual case, they are dummy programs intended to interest attackers into corrupting them instead of the other operating hosts. These honeypot systems that simulate decoy hosts are installed in a computer hardware that runs on an operating system.

Such a conventional honeypot host is shown in the FIG. 1. The honeypot host setup as shown in FIG. 1 has some limitations as it runs on a single machine configuration only. As a result, the honeypot administrators would more likely not aware that the honeypot administrators would not aware. If they can easily figured out the position of the honeypot systems, the attackers can also bring the host down. It is also very possible that the attackers may exploit and tamper based on the vulnerabilities or flaws within the honeypot software itself. If the attackers can manage to exploit, they are more likely then to have chances to demolish the whole host. Worse, they may even attempt to employ the said host as launch pad for other attacks, regardless if the honeypot host is stored inside the local network or connected to the Internet.

It is also such an inconvenience in the event that a honeypot host is compromised, the honeypot administrator would be required to move the host out of the network, then make a copy for its hard disk, and re-setup everything back to a fresh setup, to cause the honeypot host to function again. Time would be unnecessarily wasted in repetitively setting up the same honeypot system each time when the honeypot host is compromised again. Also, while the honeypot host is being installed, some other attack may be silently happening inside the local network. As a consequence, the absence of a honeypot host during a compromised situation is detrimental if the network administrator misses some of the unknown attacks.

Therefore, a honeypot host that can eliminate the aforementioned limitations is very much needed.

### SUMMARY OF THE INVENTION

Accordingly, to solve the disadvantages and drawbacks of the prior art, there is provided a honeypot host adapted for a network. The honeypot host is essentially comprised of a computer system and a honeypot system that is incorporated in the computer system.

The honeypot system is adapted to deploy at least one decoy host to at least one unused Internet Protocol (IP) address around the network. The honeypot system is further adapted to be self-replicable. In the event that a honeypot system in the network is compromised, the honeypot system is adapted to self-terminate at least a portion of the compromised honeypot system and self-replicate a new honeypot system. The honeypot system is also further adapted to detect whether the current honeypot system has been compromised.

In another aspect, the present invention also relates to a method for replicating a honeypot system to replace a compromised honeypot system in a honeypot host adapted in a network. The method essentially comprises the steps of generating the honeypot system, deploying at least one decoy host to at least one unused Internet Protocol (IP) address around the network, determining whether the honeypot system is compromised, terminating at least a portion of the honeypot system if the honeypot system is compromised, and generating a new honeypot system.

It is an object of the present invention to provide a honeypot host adapted in a network that is capable of generating a set of readily setups of honeypot host, built in the form of virtual machine running on top of a virtualization platform.

It is further an object of the present invention to provide a honeypot host adapted in a network that automatically self-generates a setup of a new honeypot system in the event that the currently running honeypot system has been compromised. The honeypot host is adapted to be completely resilient.

It is also an object of the present invention to provide a honeypot host adapted in a network that monitor and determine whether the honeypot host has been compromised, such that the compromised honeypot virtual machine is then terminated and a setup to replace the compromised honeypot virtual machine is executed.

It is a further object of the present invention to provide a honeypot host adapted in a network that would generate a new instance of a honeypot virtual machine to replace a compromised instance of a honeypot virtual machine according to the number of instances associated to the current compromised instance of the honeypot virtual machine. The number of instances is associated with the current instance of the honeypot virtual machine according to the number of honeypot virtual machines that have been generated up to the real time.

It is also an object of the present invention to fully utilize the resources on the physical hardware that the honeypot system is installed, since all the honeypot virtual machines can be configured and installed on the same physical hardware.

It is a final object of the present invention to eliminate delay that is associated with time required to handle the setups of honeypot hosts in real-time network attack situation. Furthermore, the auto-setup inherent in the present invention can assist in better response towards ever-changing attacks and threat happening inside the network.

The present invention consists of certain novel features and a combination of parts hereinafter fully described and illustrated in the accompanying drawings and particularly pointed out in the appended claims; it being understood that various changes in the details may be without departing from the scope of the invention or sacrificing any of the advantages of the present invention.

### BRIEF DESCRIPTION OF THE DRAWINGS

For the purpose of facilitating an understanding of the invention, there is illustrated in the accompanying drawings the preferred embodiments from an inspection of which when considered in connection with the following description, the invention, its construction and operation and many of its advantages would be readily understood and appreciated.

FIG. 1 shows the conventional honeypot host setups.

FIG. 2 shows a set of virtual machine-based honeypot hosts (VMHPs) running on top of a virtualization layer.

FIG. 3 shows the honeypot host setup of the present invention as compared to the conventional honeypot host setup.

FIG. 4 shows a computer system that is installed with a virtualization platform.

FIG. 5 shows a computer system with the virtualization platform that is adapted with the honeypot host components of the present invention.

FIG. 6 shows the operation flow of the honeypot host of the present invention.

FIG. 7 shows a diagram illustrating some possible attacks that may occur towards the honeypot host.

FIG. 8 shows the basic architecture of the virtualization platform with the honeypot hosts.

FIG. 9 shows an exemplary location of the honeypot host of the present invention.

FIG. 10 shows the exemplary location of the honeypot host with some fake systems (FS) deployed around the network.

FIG. 11 shows a method to create a hash value for Virtual Security Framework (VSF) image.

FIG. 12 shows a timeline illustrating the 30 seconds time interval for the Virtual Machine Controller (VNC) to generate and compare hash value of the running VSF.

### DETAIL DESCRIPTION OF A PREFERRED EMBODIMENT

The present invention relates to a honeypot host 500. More particularly, the present invention relates to a honeypot host 500 that is adapted into a network 90 to decoy hosts 80 to unused Internet Protocol (IP) addresses 160 around the network 90, and to terminate a honeypot system 300 in the host 500 and generate a new honeypot system 300 in the event that the current honeypot system 300 has been compromised. Hereinafter, a honeypot host 500 shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

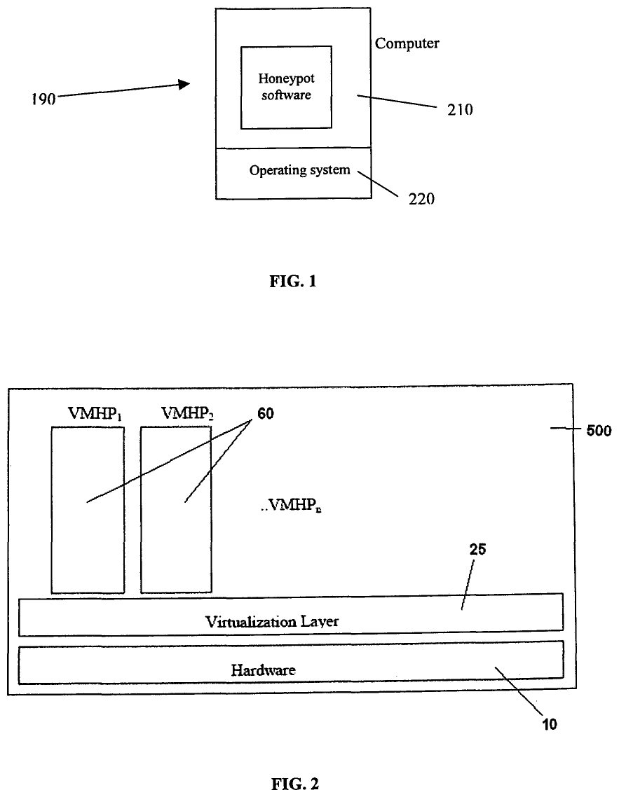

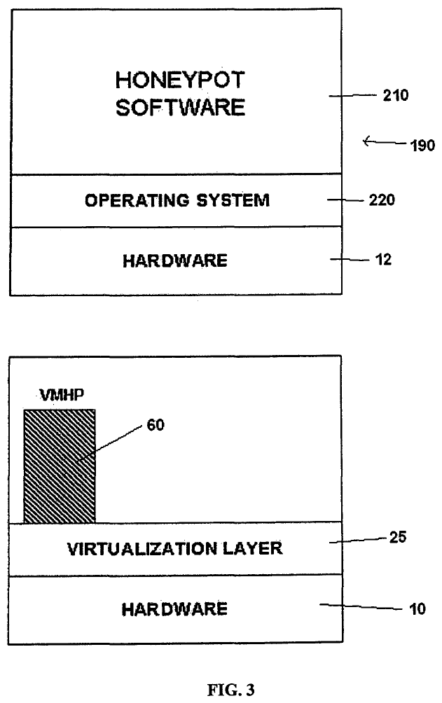

Referring now to different figures of the drawings, the honeypot host 500 of the present invention is shown. Accordingly, with reference to FIGS. 1 and 3, the conventional honeypot host setup 190 is shown. It is illustrated therein that the conventional honeypot host setup 190 is generally comprised of a hardware 12 of the host, an operating system 220, and a honeypot software 210. For the conventional setup 190, all the tools are installed into the physical hardware 12 of the computer host 190. In comparison, in the present invention, the conventional honeypot host setup 190 is functionally transformed into a virtual machine 60 that runs on top of a virtualization platform 25.

Referring now to FIG. 2, the solution provided by the honeypot host 500 of the present invention is implementation of a set of readily setup of honeypot host, built in the form of virtual machines 60. The virtual machines 60 are all adapted to run on a virtualization platform 25. The virtual machines 60 and the virtualization platform 25 will be hereinafter greatly described in more detail.

According to the present invention, the virtual machine 60 essentially adapted for the honeypot function is hereinafter referred as Virtual Machine-based Honeypot Hosts (VMHPs) 60. As there may be some attacks to the network 90, the VMHP 60 may also be compromised. The VMHP(s) 60 is therefore facilitated to be monitored and managed by some applications. Accordingly, with reference to FIG. 5, in the event that a VMHP 60 is compromised in real-time, the compromised VMHP 60a would be shut-down and a new clone of VMHP would be boot-up. All the VMHPs 60 adapted in the honeypot host 500 is preferably be repetitively shut-down and boot-up, every time a VMHP is being compromised, according to the honeypot host's 500 predefined conditions.

To exemplify this, once the current running VMHP 60, referred as VMHP₁ 60, is compromised, the instance VMHP₁ 60, would be shut-down automatically and a new VMHP 60, which is VMHP₂ 60 would then be generated, in order to replace the old and corrupted VMHP₁ 60. This sequence would be maintained until the honeypot host 500 has reached the predetermined maximum number of VMHP 60 instance.

As a consequence, the honeypot administrators would be facilitated to save lots of time in executing honeypot host setups. The honeypot host 500 of the present invention ideally implements better response towards ever-changing attacks and threats that happen inside the network 90, without unnecessary delay. The delay is associated with the time required to manage the setups of honeypot hosts in real time network attack situation.

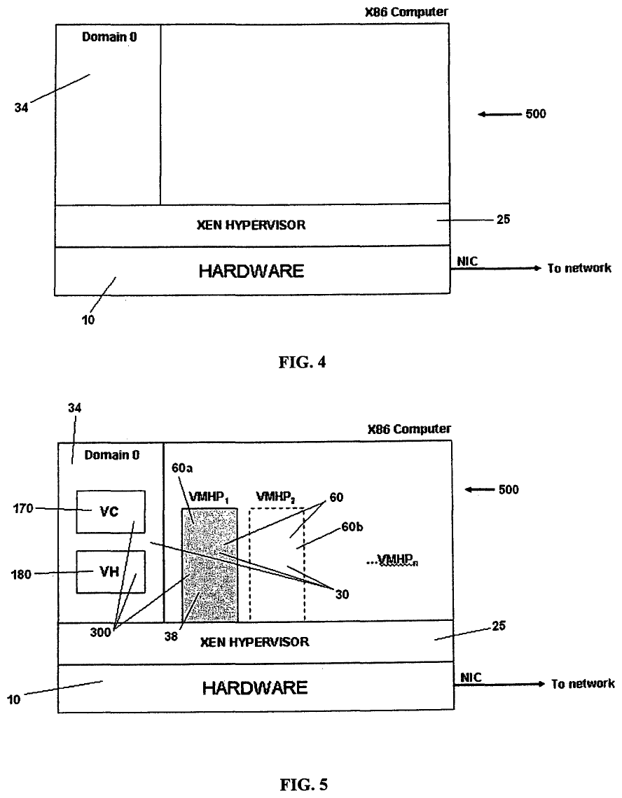

Referring now to FIGS. 4 and 8, the honeypot host 500 is constructed in such a manner that a virtualization platform component is adapted to reside on a computer system 10. The virtualization platform component is essentially adapted to generate the virtualization platform 25. The basic architecture of a virtualization platform 25 is illustrated in FIG. 8. In the field of platform virtualization, the term, virtualization platform 25 is also equivalently known as the Virtual Machine Monitor (VMM) and the hypervisor. A virtualization platform 25, as known in the art, is adapted to allow multiple operating systems to run on a host computer simultaneously.

Referring still to FIGS. 4 and 8, the virtualization platform 25 is adapted to work as an idealized hardware layer. The hardware layer is an abstraction which contains the virtualized instances of the underlying physical hardware interfaces such as a virtual control interface 110, a virtual central processing unit (CPU) 120, a virtual memory 130, and a virtual input/output (I/O) operations interface 140. In addition, operating systems 40 & 50 are adapted to run virtual machines 30 on top the virtualization platform 25. The virtualization platform 25 is therefore adapted to provide communications between the virtual machines 30 and the physical hardware 10.

Referring still to FIG. 8, the generation of virtual machines 30 is executed on a given hardware 10 by a host application, as herein referred as the host operating system 40. The host operating system 40 creates the guest virtual machines 38 for its guest operating systems 50. The guest operating system 50 would run like any other operating system running in other operating system installed in a hardware in conventional method as illustrated in FIGS. 1 and 3. The host operating system 40 runs directly on the hardware 10 whilst the guest operating system 50 runs on the second level above the hardware 10. The guest operating systems 50 each are adapted to run the guest virtual machines 38.

Referring now to FIGS. 5 and 8, the host operating system 40 is also adapted to create and run a host virtual machine 34 on the virtualization platform 25. The host operating system 40 is provided with access to the computer system 10, the access to the virtual control interface 120, and the mechanism that enables other guest operating system 50 to be created, destroyed and managed. As a result, the management and the control software would run in the host operating system 40. According to the most preferred embodiment of the present invention, the present invention is most preferably adapted in IPv4 network environment and it can only be deployed inside the production network environment. The present invention can also be implemented on both 32 bit and 64 bit architecture. It is also most preferred that Xen virtualization software is used as the virtualization platform 25 of the present invention as shown in FIG. 4.

The host operating system 40 is also referred as “domain 0” according to the most preferred embodiment. The host operating system 40 is therefore booted automatically when the virtualization platform 25 is booted. The host operating system 40 is also provided with privileges in management as well as access to the hardware 40. Although the most preferred embodiment is stated herein as such, other combinations or components may also be used for the development of the present honeypot host (500) of the similar forms.

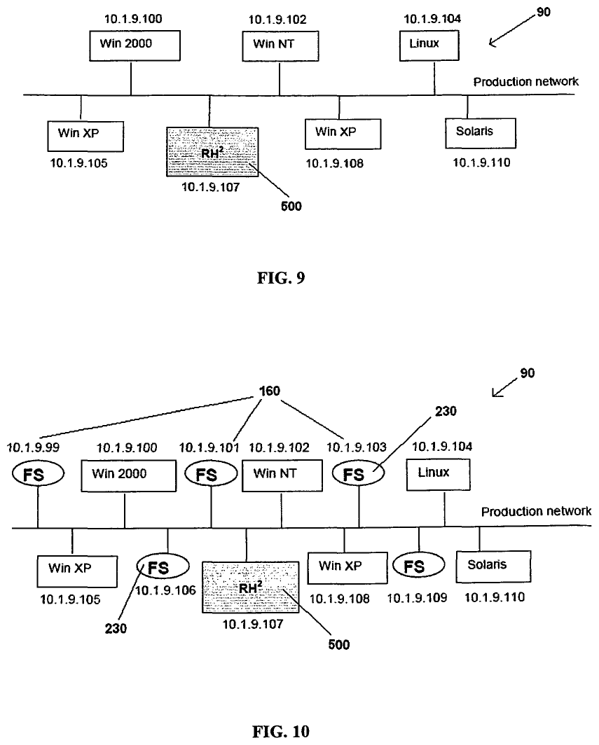

With reference to FIG. 5, the VMHP 60 comprises two components, namely the fake system emulator (FSE) and a simplified operating system. The FSE is adapted to enable the deployment of the decoy hosts to the unused IP address 160 around the network 90, as illustrated in FIG. 10. The location of the honeypot host 500 among other terminals is shown in FIG. 9. It is preferred that the FSE comprises a virtual honeypot application and a preconfigured script. The virtual honeypot application is preferably a Honeyd, an open source virtual honeypot application whilst the script is preferably the preconfigured Honeyd script. The script is adapted to build up a workable FSE. The execution of the virtual honeypot application depends on the emulation settings configured within the script.

In the present invention, it is also preferred that the second component that construct the VMHP 60 is the Simplified Operating System (SOS). The SOS is preferably a stripped-down version of Linux-based operating system. The SOS is also essentially provided by discarding away the packages that do not directly contribute to the running of the VMHP(s) 60.

The honeypot host 500 of the present invention also comprises two applications that are adapted and operated in the host operating system 40, the “domain 0” of the virtualization platform 25 as shown in FIG. 5. The applications are the VMHP Control, hereinafter referred as VC 170 and VMHP hashcheck, hereinafter referred as VH 180. The VC 170 is essentially adapted to trigger the VH 180 to perform hashcheck in every predetermined interval time. The predetermined interval time is preferably 30 seconds according to the most preferred embodiment. The VC 170 is therefore adapted to have a built-in timer (30 seconds interval) for the VH 170 triggering.

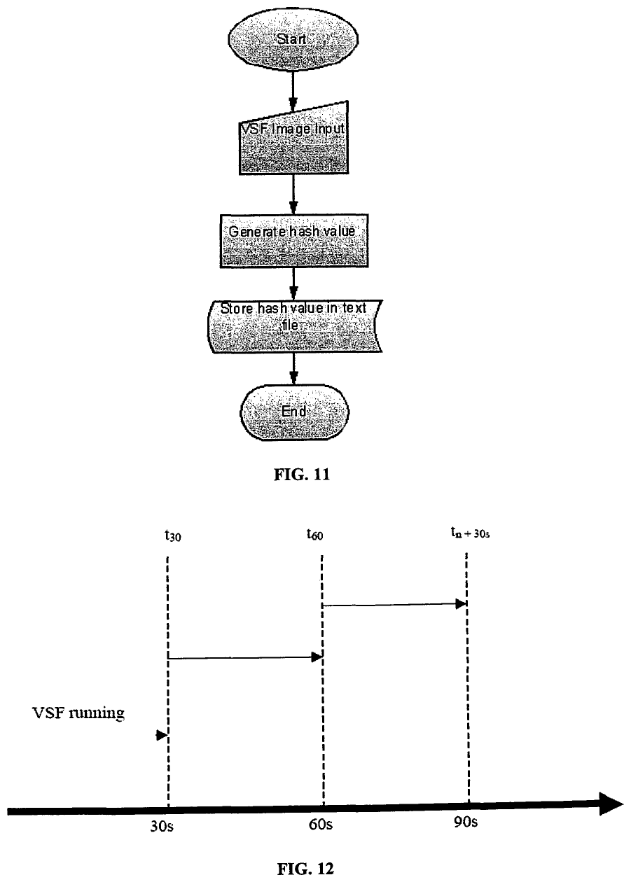

The VH 170 is essentially adapted to generate a hash value for the VMHP instance 60, and compare the real-time hash value with the initial hash value for the currently running VMHP instance 60. The initial hash value is preferably captured during the development of the VMHP 60. All the captured (initial and real-time) hash values are stored within the VH 180. Both the VC 170 and the VH 180 are incorporated in the host virtual machine 34 run by the host operating system 40. According to the most preferred embodiment, the VC and the VH are incorporated in the “domain 0” of the virtualization platform 25. With reference to FIG. 11, the hash value is shown created by means of a Virtual Security Framework (VSF) image. The operation would begin by using the VSF image as input to generate hash value. The process then generates hash value and stored it in a text file. All the process would be terminated in the end of the hash value generation. The preferred timeline illustrating the 30 seconds time interval for the controlling component 170 to generate and compare hash value of the running VSF is shown in FIG. 12.

It is also preferred that the honeypot host 500 of the present invention comprises a number of instances determination component (not shown). The number of instances determination component is incorporated in the host virtual machine 34 run by the host operating system 40. According to the most preferred embodiment, the number of instances determination component are incorporated in the “domain 0” of the virtualization platform 25. The number of instances determination component is adapted to check the number of instances of the running honeypot virtual machine 60. The number of instances is associated with the number of honeypot virtual machines 60 that have been generated up to the real time. The said determination component is essentially adapted to assign a number of instances to any generated honeypot virtual machine (60) at the real-time. The number of instances determination component is adapted such that if the number of instances has not reached the predetermined maximum number, the compromised honeypot virtual machine 60a is terminated and a new honeypot virtual machine 60b is generated. Also, the number of instances determination component is adapted to cause termination of the compromised honeypot virtual machine (60a) and stop generating of a new honeypot virtual machine 60b to replace the compromised honey pot virtual machine 60a, if the number of instances has reached the predetermined maximum number. As afore-mentioned, the predetermined maximum number is preferably 10.

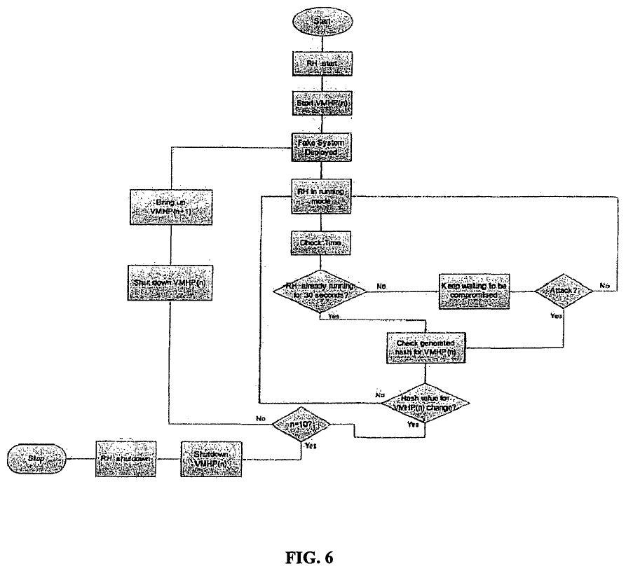

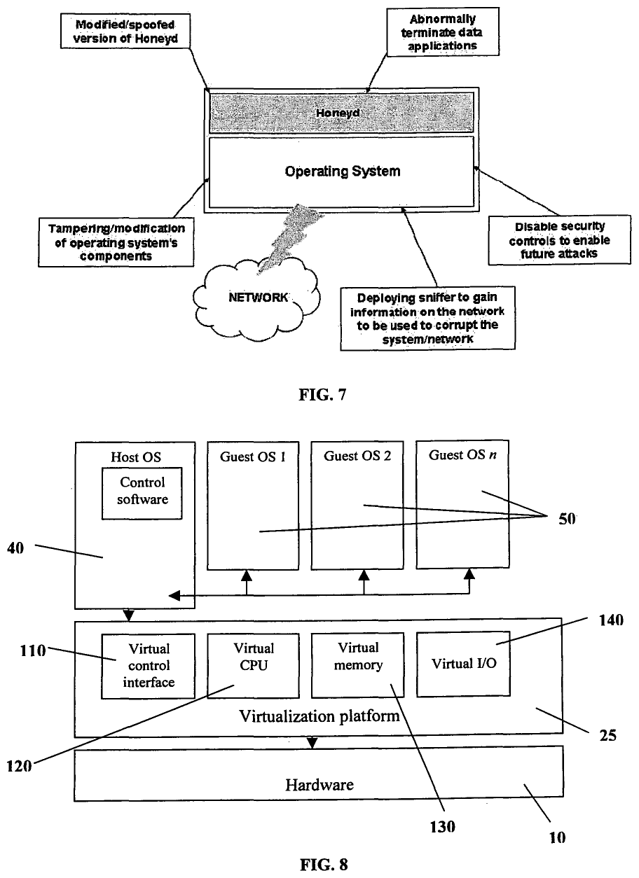

Referring now to FIG. 6, in another aspect of the present invention, the present invention also relates to a method for replicating a honeypot system 300 to replace a compromised honeypot system 300 in a honeypot host 500 adapted in the network 90. The honeypot host 50 begins to operate once it is plugged-in inside the local network 90. The first instance of the VMHP₁ 60 is generated as shown in FIG. 5. The FSE in the VMHP₁ 60 would be triggered next. The FSE would deploy the emulated decoy systems/hosts 80 to all unused IP addresses 160 around the local network 90 where the honeypot host 500 resides, as illustrated in FIG. 10. The emulated decoy systems 230 are adapted to be in listening mode and this shows that the honeypot host 500 is in running mode. While the honeypot host (500) is running, the VC 170 application in the host virtual machine 34, or preferably the Domain 0, would trigger VH 180 when the timer reaches every preferred 30 seconds interval. If the timer within VC 170 indicates that the running of the honeypot system 300 has arrived at the preferred 30 seconds checkpoint, VC 170 would trigger VH 180.

VH 180 then generates the hash value for the current VMHP instance 60 and compares the hash value with the initial hash value stored in the VH 180. The comparison is executed to determine the changes in the said hash values. Changes in the hash values denote that the VMHP 60 has been compromised. If the hash value for the current VMHP instance 60 is changed, the number of instances determination component would then check the number (n) assigned to the currently running VMHP instance 60, whether the number, n is equivalent to the predetermined maximum number (preferably n=10) or not. The first VMHP instance is VMHP₁60 so that the n that is assigned to this instance is 1 and 1 is not equivalent to 10. This denotes that the VMHP instance 60 has not reached 10 yet (since the preferred maximum set of VMHP instance 60 adopted for the present invention is up to 10 only).

Referring now to FIG. 5, if the n is not equivalent to 10, the honeypot host 500 would terminate the VMHP instance 60 and generate a new VMHP instance 60 with the new n, incremented by one (n+1), assigned to the instance, i.e. VMHPₙ₊₁ 60. The steps would be repeated again with the new instance 60 as illustrated in FIG. 6. The honeypot host 500 would again run with this new VMHP instance 60. If n is equal to 10, the honeypot host 500 would terminate the running VMHP 60. Then, there would be no new VMHP instance 60 generation. The honeypot host 500 would automatically shut down itself. If the hash value for the current VMHP 60 is not changed, the honeypot host 500 would continue its function and would be running with the same VMHP instance 60, which is VMHP₁ 60 as illustrated in FIG. 6.

According to the most preferred embodiment of the present invention, the honeypot host 500 is constructed on top of a workable virtualization platform 25, in which the computer system 10 is preferably an x86 computer preinstalled with Linux operating system and Xen virtualization software as shown in FIG. 4.

While in the foregoing specification this invention has been described in relation to certain preferred embodiments thereof and many details have been set forth for purpose of illustration, it will be apparent to those skilled in the art that the invention is susceptible to additional embodiments and that certain of the details described herein can be varied considerably without departing from the basic principles of the invention.

1. A honeypot host adapted in a network comprising:
a computer system; and a honeypot system incorporated in the computer system, wherein the honeypot system is adapted to deploy at least one decoy host to at least one unused Internet Protocol (IP) address around the network;
characterized in that the honeypot system is further adapted to be self-replicable such that in the event that a honeypot system in the network is compromised, the honeypot system is capable of self-terminating at least a portion of the compromised honeypot system and self-replicating a new honeypot system; and the honeypot system is further adapted to detect whether the current honeypot system has been compromised.

2. A honeypot host as claimed in claim 1, wherein the honeypot system comprises at least one honeypot virtual machine adapted on the virilization platform, and a honeypot virtual machine generation and termination unit adapted on a virtualization platform adapted in the computer system; characterized in that the honeypot virtual machine executes the function of deploying at least one decoy host to at least one unused Internet Protocol (IP) address around the network; and the generation and termination unit executes the function of determining whether the honeypot virtual machine is compromised, and to terminate the compromised honeypot virtual machine and generate a new honeypot virtual machine.

3. A honeypot host as claimed in claim 2, wherein the honeypot virtual machine further comprises of a fake system emulation component; characterized in that the fake system emulation component is adapted to enable the deployment of the at least one decoy host to at least one unused IP address around the network.

4. A honeypot host as claimed in claim 2, wherein the honeypot virtual machine operates as a guest virtual machine running on the virilization platform.

5. A honeypot host as claimed in claim 2, wherein the generation and termination unit comprises a number-of-instances determination component; the determination component is adapted to assign a number of instances to the generated honeypot virtual machine; the determination component is further adapted to check the number of instances of the running honeypot virtual machine if the honeypot virtual machine is compromised; characterized in that the number of instances is associated with the current instance of the honeypot virtual machine according to the number of honeypot virtual machines that have been generated up to the real time; the number of instances determination component is further adapted such that if the number of instances has not reached the predetermined maximum number, the compromised honeypot virtual machine is terminated and a new honeypot virtual machine is generated; and if the number of instances has reached the predetermined maximum number, the compromised honeypot virtual machine is terminated without the generation of a new honeypot virtual machine to replace the compromised honeypot virtual machine.

6. A honeypot host as claimed in claim 2, wherein the generation and termination component further comprises a honeypot virtual machine controlling component and a honeypot virtual machine hashcheck component; characterized in that the controlling component is adapted to trigger the hashcheck component to perform hashcheck every predetermined interval time; the hascheck component is adapted to generate hash value for the honeypot virtual machine's instance, and compare the real time hash value with the initial hash value for the current honeypot virtual machine's instance; the initial hash value is captured during the development stage of the generated honeypot virtual machine's instance; the real time and initial hash values are stored in the hashcheck component; the changes in the compared hash values denote that the honeypot virtual machine has been compromised; and the hashcheck is triggered based on the controlling component's call.

7. A honeypot host as claimed in claim 6, wherein the predetermined interval time is substantially 30 seconds.

8. A honeypot host as claimed in claim 5, wherein the predetermined maximum number of instances is 10.

9. A honeypot host as claimed in claim 6, wherein the controlling component comprises a timer to facilitate the controlling component to trigger the hashcheck component in every predetermined interval time.

10. A honeypot host as claimed in claim 6, wherein the hash value of honeypot virtual machine instance is generated by using a Virtual Security Framework (VSF) image characterized in that the VSF image is used as an input to generate a hash value of the honeypot virtual machine instance, the hash value is then stored in a text file in the hashcheck component.

11. A method for replicating a honeypot system to replace a compromised honeypot system in a honeypot host adapted in a network, the method comprises the steps of:
generating the honeypot system; deploying at least one decoy host to at least one unused Internet Protocol (IP) address around the network wherein a fake system emulator of the honeypot virtual machine is triggered; determining whether the honeypot system is compromised; terminating at least a portion of the honeypot system if the honeypot system is compromised; and generating a new honeypot system.

12. A method for replicating the honeypot system as claimed in claim 11, further comprises the step of adapting a honeypot system into a virtualization platform adapted on the computer system; characterized in that the step of adapting a honeypot system is executed before the step of generating the honeypot system.

13. A method of replicating the honeypot system as claimed in claim 11, wherein the step of generating the honeypot system comprises the step of generating an instance of a honeypot virtual machine; and the step of generating an instance of a honeypot virtual machine comprises the step of assigning a number of instances to the current instance of the honeypot virtual machine; characterized in that the number of instances is associated with the current instance of the honeypot virtual machine according to the number of honeypot virtual machines that have been generated up to the real time.

14. A method of replicating the honeypot system as claimed in claim 11, wherein in the step of deploying at least one decoy host, the deployment is executed by the honeypot virtual machine.

15. A method of replicating the honeypot system as claimed in claim 13, wherein the step of determining whether the honeypot system is compromised comprises the step of determining whether the instance of honeypot virtual machine is compromised at every predetermined interval time.

16. A method of replicating the honeypot system as claimed in claim 15, wherein the step of terminating at least a portion of the honeypot system comprises the step of terminating the compromised instance of the honeypot virtual machine.

17. A method of replicating the honeypot system as claimed in claim 13, wherein the step of generating an instance of a honeypot virtual machine further comprises the step of generating an initial hash value for the current instance of the honeypot virtual machine by a hashcheck component.

18. A method of replicating the honeypot system as claimed in claim 17, wherein the step of determining whether the instance of honeypot virtual machine is compromised comprises the step of generating a real-time hash value for the current instance of the honeypot virtual machine, and comparing the initial and the real-time hash value for said current instance; characterized in that the hashcheck component is triggered by a controlling component in every predetermined interval time to generate the real-time hash value and to compare the initial and the real-time hash values for said current instance; and the changes in the compared hash values denote that the instance of the honeypot virtual machine has been compromised.

19. A method of replicating the honeypot system as claimed in claim 16, wherein the step of terminating the compromised instance of the honeypot virtual machine comprises the step of checking the number of instances of the current instance of the honeypot virtual machine.

20. A method of replicating the honeypot system as claimed in claim 19, wherein in the step of generating a new instance of the honeypot virtual machine, the new instance of the honeypot virtual machine is generated if the number of instances has not reached the predetermined maximum number, and the new instance is ceased to be generated once the number of instances has reached the predetermined maximum number.

21. A method of replicating the honeypot system as claimed in claim 18, wherein the step of generating a real-time hash value for the current instance of the honeypot virtual machine comprises the steps of generating the hash value by using a Virtual Security Framework (VSF) image; characterized in that the VSF image is used as an input to generate hash value, the hash value is then generated and stored in a text file.
